(19) United States
(12) Patent Application Publication
(10) Pub. No.: US 2014/0131924 A1
(43) Pub. Date: May 15, 2014

(54) METHODS OF FORMING A POLYMERIC COMPONENT

(71) Applicant: Derek James Wallace McMinn, West Midlands (GB)

(72) Inventor: Derek James Wallace McMinn, West Midlands (GB)

(21) Appl. No.: 14/126,273

(22) PCT Filed: Jun. 15, 2012
(86) PCT No.: PCT/GB2012/000522

§ 371 Date: Jan. 23, 2014

(30) Foreign Application Priority Data
Jun. 15, 2011 (GB) 1110097.1
Jan. 13, 2012 (GB) 1200708.4

(51) Int. Cl. B29C 43/18

(52) U.S. Cl. CPC B29C 43/18
USPC 264/488; 264/139

(57) ABSTRACT

A method of forming a plurality of polymeric components comprises the steps of: providing an array of preforms (10), each preform (10) comprising crosslinked polymeric material; providing non-crosslinked polymeric material (28) around at least a portion of each preform (10); fusing the array of preforms (10) to the non-crosslinked polymeric material (28) so as to form a plurality of hybrid components; removing a portion of each preform (10) so as to deposit a crosslinked surface layer on the non-crosslinked polymeric material (28); and fashioning the hybrid components into the plurality of polymeric components. The polymeric components may constitute the whole or a part of a prosthesis, such as an acetabular cup prosthesis for use in hip resurfacing.

### FIELD OF THE INVENTION

The present invention relates to methods of forming a polymeric component. In particular embodiments, the polymeric component may constitute the whole or a part of a prosthesis such as an acetabular cup prosthesis for use in hip resurfacing.

### BACKGROUND TO THE INVENTION

Hip resurfacing is commonly performed using acetabular cups and femoral components which are made from solid metal. However, it has been estimated that approximately 1% of patients who undergo such metal-on-metal hip resurfacing have a pseudo-tumour in the form of a soft tissue mass or large symptomatic effusion within 5 years. The symptoms of these pseudo-tumours include discomfort, spontaneous dislocation, nerve palsy, a noticeable mass and a rash, while the common histological features are extensive necrosis and lymphocytic infiltration. As a consequence, many patients require revision surgery followed by conventional total hip replacement.

Whilst the cause of these pseudo-tumours is currently unconfirmed, it has been observed that they occur in situations of high bearing wear. This could be caused by poor wearing metal as a result of non-optimal heat treatment during processing or due to component misalignment, which may either result from the surgeon mal-positioning one or more of the components or from an underlying bony misalignment of the skeleton (e.g. developmental dysplasia of the hip). Edge wear of the acetabular component has also been observed along with excessive wear of the femoral component due to impingement.

It is believed that the pseudo-tumours may, in fact, be due to a toxic reaction to an excess of particulate metal wear debris or metal ions or, perhaps, a hypersensitivity reaction to a normal amount of metal wear debris. There is therefore a concern that, with time, the incidence of these pseudo-tumours may increase.

Other materials have been considered for use in hip resurfacing. For example, a metal outer cup shell has been combined with a polymer (e.g. conventional non-crosslinked polyethylene) inner cup liner. However, in these instances an even higher failure rate is encountered because wear of the bearing surface leads to early loosening of the joint and the production of large quantities of polymer debris. This results in osteolysis of the acetabulum and femur, making revision surgery difficult due to the loss of bone stock.

More recently, crosslinked polymers have been employed to provide acetabular cup prosthesis having improved wear-resistance. In general, the crosslinking of such polymer material (e.g. polyethylene) is performed by irradiating bar stock or a finished product after consolidation. However, free radicals are an unwanted by-product of this process as they can lead to oxidation which can make the material brittle. Re-melting of the crosslinked polymer is therefore commonly performed to eliminate the free radicals but this, in turn, has been found to deteriorate the mechanical properties of the polymer.

It is also known to irradiate polyethylene resin (powder, particles or flakes) in air or a reduced oxygen atmosphere so as to minimise oxidation. After the polyethylene resin has been crosslinked the material is consolidated (e.g. by compression moulding). The problem with this approach, however, is that the very large surface area of the polyethylene resin permits oxidation of the material during or after irradiation, even when irradiation is carried out in a reduced oxygen atmosphere. It is believed that one reason for this problem of oxidation during irradiation or during subsequent moulding of the irradiated particles is that approximately 5% oxygen can be contained within the polymer (e.g. polyethylene) particles (e.g. in the interstices thereof). The free radicals produced during irradiation can thus combine with the oxygen contained in the polymer particles. The resulting oxidized polymer is of a poor quality since it will be susceptible to severe wear and fracture due to mechanical weakening.

According to the known art, if an antioxidant blended polymer powder is consolidated by heat and pressure (e.g. by compression moulding) the antioxidant (e.g. vitamin E) will diffuse from the surface of the polymer powder into every molecule of the polymer under the influence of heat from the consolidation process. In the case of polyethylene the diffusion is into the loosely formed, amorphous phase of each polyethylene molecule (which accounts for about 50% of each polyethylene molecule). The crystalline phase is much tighter packed and harder to diffuse substances into. When the antioxidant containing consolidated polyethylene cools and is irradiated the antioxidant hinders crosslinking for the following reasons. It is the amorphous phase that is largely involved in crosslinking. Irradiation normally results in crosslinking by causing scissions in the polyethylene molecular chains. These scissions have free radicals on the ends of the broken chains. The broken ends tend to link with other surrounding molecular chain ends or sides so producing a crosslinked structure. However, when antioxidant is present in the amorphous phase, the antioxidant neutralises the free radicals on the broken chain ends, thus inhibiting crosslinking.

There is therefore a need for an effective method of producing a polymeric material suitable for prosthesis and having a strong (non-crosslinked) body and a wear-resistant (crosslinked) bearing surface.

It is currently known to produce such prosthetic components by direct compression moulding (DCM). However, some disadvantages of DCM are that bespoke tooling is required for every size of component and it is only usually practical to produce between 8 and 12 components from a single mould tool in a 24 hour period.

Commonly, acetabular cups are configured for press-fit fixation (e.g. by forcing a 50 mm outer diameter component into a 48 mm diameter hole). This can result in considerable deformation (e.g. in the range of 100 microns to over 350 microns), even where thick metal shells are employed, and so there is a risk that the cup will grip the femoral component leading to early acetabular component breakout. Alternative fixation features, such as large projecting pegs, are therefore sometimes employed. However, it has not previously been considered viable to attempt to fix modular fixation pegs to the external surface of a polyethylene cup because of the poor mechanical properties of polyethylene for such attachment.

It is therefore an aim of the present invention to provide a method of forming a polymeric component (e.g. for a prosthesis such as an acetabular cup), which helps to ameliorate some of all of the afore-mentioned problems.

### SUMMARY OF THE INVENTION

According to a first aspect of the present invention there is provided a method of forming a plurality of polymeric components comprising:
providing an array of preforms, each preform comprising crosslinked polymeric material;
providing non-crosslinked polymeric material around at least a portion of each preform;
fusing the array of preforms to the non-crosslinked polymeric material so as to form a plurality of hybrid components;
removing a portion of each preform so as to deposit a crosslinked surface layer on the non-crosslinked polymeric material; and
fashioning the hybrid components into said plurality of polymeric components.

Embodiments of the present invention therefore provide a method which can be used to mass produce polymeric components having a crosslinked surface and non-crosslinked body or supporting layer. Advantageously, no bespoke tooling is required and a variety of different sizes or shapes of components can be produced at once. For example, it is possible for the present method to be employed to produce approximately 2,200 components from a single tool, within a 24 hour period. The method is particularly suitable for use in the manufacture of prosthetic parts.

The depositing of the crosslinked surface on the non-crosslinked polymeric material can be considered a form of grafting.

The array of preforms may be constituted by a plurality of interconnected preforms, which may be provided on an interconnecting web, tree or plane. Alternatively, the array may be formed by placing a plurality of preforms in touching contact or in proximity with each other, (e.g. on a mould).

The array need not have multiple rows and multiple columns of preforms and each preform need not be aligned with the next. All that is required is a minimum of two preforms arranged proximally to each other prior to the step of providing non-crosslinked polymeric material around at least a portion of each preform.

An outer surface of each preform may form an interface with the non-crosslinked polymeric material. Each preform may have a digitated or roughened portion to help in fusing the crosslinked polymeric material to the non-crosslinked polymeric material.

The step of fusing the preforms to the non-crosslinked polymeric material may comprise compression moulding. Hot compression moulding may be employed to melt the preforms and the non-crosslinked polymeric material so that they fuse together on cooling.

The plurality of hybrid components may be conjoined in a block or slab of polymeric material.

The preforms may be configured for attachment to a location and/or handling tool. Accordingly, the preforms may comprise a socket for receipt of a plug having a higher melting point than the crosslinked polymeric material (e.g. the rod may comprise metal and/or polyetheretherketone, also known as PEEK). Alternatively, the preforms may comprise a plug for insertion into a socket of a location and/or handling tool.

In certain embodiments, the plug is constituted by a rod which is inserted into the preform prior to the fusing of the preforms to the non-crosslinked polymeric material so as to form the plurality of hybrid components. The rod is removed after fusing and a cutting tool may be used, which takes reference from the location of the socket so as to remove a required portion of the preform to deposit the crosslinked surface layer on the non-crosslinked polymeric material.

Where the polymeric components are configured as acetabular cup bearing components, the preforms may be part-spherical (e.g. hemi-spherical) and may each be joined by a cylindrical trunk to a planar substrate. The part-spherical portion may have an exterior surface which is roughened to aid attachment to the non-crosslinked material. The socket may be constituted by a test-tube shaped cavity provided through the substrate and along a central axis of the trunk. In one embodiment, a centre of curvature of a tip of the socket is coincident with a centre of curvature of the part-spherical surface. Non-crosslinked polymer powder is placed around the preforms to completely fill gaps provided between the trunks and the part-spherical surfaces of each preform. The fusing step is then carried out with a first mould plate provided on the planar surface of the substrate and a second mould plate provided above the part-spherical portion of the preforms to accommodate a sufficient thickness of the non-crosslinked polymer powder therebetween.

After fusing (e.g. moulding), a block of material may be formed and the only indication of the position of each preform may be provided by the positions of the sockets and, more specifically, the centre of curvature of the tips of the sockets. Accordingly, the rods may be removed and the cutting tool may be employed to remove a pre-determined portion of the preform so as to leave a desired thickness of crosslinked surface layer on the non-crosslinked material. The hybrid components may then be machined into part-spherical acetabular cups having the crosslinked surface layer constituting the whole or a part of the inner articular bearing surface.

The crosslinked surface layer may extend to the edge of the acetabular cup or a portion of the surrounding non-crosslinked material may be maintained along the edge.

In certain embodiments, the thickness of the crosslinked surface layer may be constant or it may be varied, for example, by machining the preform to create a tapered edge to the crosslinked surface layer.

The method may comprise providing a further crosslinked polymeric layer on the non-crosslinked polymeric material. This may be achieved by fusing the non-crosslinked polymeric material to a base of crosslinked polymeric material, prior to, subsequent to or at the same time as the step of fusing the preforms to the non-crosslinked polymeric material. In certain embodiments, the non-crosslinked material may be sandwiched between the preforms and the base of crosslinked polymeric material. The base may be provided in the form of powdered crosslinked polymeric material or may be pre-consolidated. The base may contain antioxidant to reduce oxidation. The base may be formed into a further surface layer on the non-crosslinked polymeric material. The base may have a digitated or roughened portion to help in fusing the crosslinked polymeric material to the non-crosslinked polymeric material.

In particular embodiments, the crosslinked surface layer and the further surface layer may constitute front and rear bearing surfaces of the polymeric components. The polymeric components may constitute dual mobility acetabular bearings for use in total hip replacements. The front and rear bearing surfaces may have centres that are not coincident. In one embodiment, the non-crosslinked polymeric material may be thinnest in a central region between the crosslinked surface layer and the further surface layer. The non-crosslinked polymeric material may have a free edge which is not in contact with crosslinked polymeric material and which is configured to withstand impingement by a femoral component, when in use.

The step of fashioning the hybrid components may comprise separating the hybrid components and/or machining the hybrid components into a pre-defined shape.

The polymeric components may constitute the whole or a part of a product. Alternatively, the polymeric components may constitute bar stock from which a product or a part of a product may be made (e.g. machined). The product may be constituted by a bearing component, a medical device, or a prosthesis. The prosthesis may be for use in any joint, for example, the hip, knee, spine, neck, jaw, ankle, toe, shoulder, elbow, wrist, finger or thumb.

Where the polymeric components form a part of a product, the part may form a surface of the product, in particular, a surface that is normally expected to be subjected to wear (e.g. a bearing surface). The part may constitute the whole or a part of at least one surface of a product, such as an articular surface of a prosthesis.

A component formed by the present method may therefore comprise partial articular surface crosslinking or full articular surface crosslinking. Both the front and back elements of a modular polymer bearing insert (e.g. an insert for dual mobility hip bearings) may be formed comprising crosslinking to reduce front and back wear.

The crosslinked polymeric material may be formed by chemical or radiation crosslinking of a polymeric starting material. The polymeric starting material may be in the form of powder, flakes, resin or a consolidation.

The preforms may be consolidated by compression moulding, direct compression moulding, or ram extrusion. The preforms may be irradiated to induce crosslinking before, during or after consolidation.

In particular embodiments, the preforms may be formed by machining a compression moulded bar stock of polymer particles, wherein the bar stock has been irradiated to induce crosslinking before, during or after moulding.

The crosslinked polymeric material and/or the non-crosslinked polymeric material may comprise an antioxidant (e.g. vitamin E).

In the case of the crosslinked polymeric material, the antioxidant may be introduced to (e.g. blended with or doped into) the polymeric material before, during or after crosslinking. It should be noted that the presence of an antioxidant will help to reduce oxidation. Accordingly, the method of the present invention may be carried out in an oxygen-containing atmosphere (e.g. air) as the risk of oxidation (by combination of oxygen with free radicals during the moulding process) will be minimised due to the presence of the antioxidant. This also means that large moulding apparatus (e.g. presses) can be employed to produce many components at once since tight control of the surrounding environmental conditions is not required (i.e. it is not necessary to perform the method in a vacuum or inert environment). Furthermore, the presence of antioxidant in the crosslinked polymer material means that relatively long moulding cycles (up to 24 hours) can be used without increasing the risk of oxidation of the preforms.

It is noted that, in the prior art, if unwanted oxidation occurs to crosslinked polymeric material, it is often possible to machine off the affected (oxidised) surface and use the non-oxidised material beneath. However, in embodiments of the present invention it is the surface layer of the crosslinked polymeric performs that is retained on the hybrid components. Thus, although a portion of each preform is removed, this is only performed after the surface of the preforms has been fused to the non-crosslinked material. Accordingly, the surface layer of the preforms becomes the surface layer of the hybrid components (albeit with the outer portion of the surface of the preform forming the junction with the non-crosslinked material and the inner portion of the surface of the preform forming the external surface of the hybrid component). In many embodiments, the external surface of the hybrid component will form the whole or a part of an articular bearing surface.

The applicant has found that, if radiation crosslinked consolidated polyethylene is placed in a mould next to powder polyethylene, even if the powder polyethylene has been blended with vitamin E and the crosslinked consolidated polyethylene has been re-melted to eliminate free radicals before moulding to the powder polyethylene, the consolidated crosslinked polyethylene will fuse well with the polyethylene powder during the heating & pressure of moulding but the original crosslinked polyethylene will also oxidise during the moulding process. Similarly, when moulding crosslinked polyethylene powder as a surface layer to a non-crosslinked backing layer of polyethylene powder, the crosslinked material was found to oxidise during moulding.

Embodiments of the present invention aim to overcome this deficiency by including an antioxidant in the consolidated crosslinked polymer preforms before they are fused (i.e. moulded) to the non-crosslinked polymeric material. The applicants have found that in such embodiments oxidation was minimized to an insignificant level during the moulding process. In an example of such an embodiment, 0.1% by weight of vitamin E was blended with polymer powder and the mixture was then irradiated with a dose of 150 kGy to provide a sufficiently crosslinked polymer powder which was then subsequently consolidated and formed into the preforms.

In another embodiment, polymer powder may be consolidated (either directly into the preforms or into a bar stock from which the preforms are derived) and then doped by diffusion of an antioxidant, before, during or after the consolidation is irradiated to induce crosslinking.

Where the antioxidant is blended with polymer particles, the antioxidant should substantially coat the surfaces of all of the polymer particles present. The polymer particles may be provided in the form of a resin (e.g. comprising powder, flakes and/or small pellets) or a hydrogel (e.g. comprising a polymer capable of absorbing water). The polymer particles may comprise a plurality of molecules.

The polymeric material may comprise the following but is not limited thereto: polyethylene, polypropylene, polyamide, polyimide, polyether ketone, or any polyolefin, including high-density-polyethylene, low-density-polyethylene, linear-low-density-polyethylene, ultra-high molecular weight polyethylene (UHMWPE), copolymers and mixtures thereof; hydrogels such as poly(vinyl alcohol), poly(ethylene glycol), poly(ethylene oxide), poly(acrylic acid), poly(methacrylic acid), poly(acrylamide), copolymers and mixtures thereof; copolymers and mixtures of a hydrogels with any polyolefin.

The antioxidant may be provided in the form of a liquid, powder, solution or suspension. For example, a powder (or liquid) antioxidant may be dissolved in a solvent such as alcohol to increase the volume of the antioxidant containing element and allow it to more easily coat the polymer particles. The solvent may be evaporated off after the blending. Alternatively, for example for insoluble antioxidants, the bulk of the antioxidant containing element can be increased by placing the antioxidant in a suspension of liquid (e.g. water).

The antioxidant may comprise the following but is not limited thereto: vitamin E; alpha-tocopherol, delta-tocopherol; propyl, octyl, or dedocyl gallates; lactic, citric, ascorbic, tartaric acids; organic acids and their salts; orthophosphates; tocopherol acetate and Irganox 1010.

In certain embodiments of the present invention, the antioxidant (e.g. vitamin E) may constitute up to 3% by weight or volume of the polymeric material. In particular embodiments, the antioxidant (e.g. vitamin E) may constitute 0.1%, 0.5%, 1%, 2%, or 3% by weight or volume of the polymeric material.

According to a second aspect of the present invention there is provided a method of forming a polymeric component having two or more bearing surfaces comprising:
providing a base of crosslinked polymeric material and a compressor of crosslinked polymeric material;
providing non-crosslinked polymeric material between the base and the compressor;
fusing the non-crosslinked polymeric material to the base and the compressor to form a hybrid component;
removing a portion of the compressor so as to deposit a crosslinked surface layer on the non-crosslinked polymeric material; and
fashioning the hybrid component to form said polymeric component.

The method may comprise the step of removing a portion of the base so as to deposit a further crosslinked surface layer on the non-crosslinked polymeric material.

The step of fusing the non-crosslinked polymeric material to the base and the compressor may comprise a first step of fusing the non-crosslinked polymeric material to the base or compressor (e.g. by compression moulding) followed by a second step of fusing the non-crosslinked polymeric material to the other of the base or compressor (e.g. by compression moulding). Alternatively, the non-crosslinked polymeric material may be fused to the base and the compressor in a single operation.

An array of compressors constituting the preforms of the first aspect of the invention may be employed in the second aspect of the invention to form a plurality of polymeric components having two or more bearing surfaces. The compressors may therefore comprise any of the features described above in relation to the preforms.

The base may be provided in the form of powdered crosslinked polymeric material or may be pre-consolidated. The base may contain antioxidant to reduce oxidation. The base may have a digitated or roughened portion to help in fusing the crosslinked polymeric material to the non-crosslinked polymeric material.

The polymeric component may constitute a dual mobility acetabular bearing having front and rear bearing surfaces for use in total hip replacements. The front and rear bearing surfaces may have centres that are not coincident. In one embodiment, the non-crosslinked polymeric material may be thinnest in a central region between the compressor and the base. The non-crosslinked polymeric material may have a free edge which is not in contact with crosslinked polymeric material of the compressor or the base and which is configured to withstand impingement by a femoral component, when in use.

In particular embodiments in which the polymeric components form a part or the whole of a prosthesis, for example, an acetabular cup prosthesis, the external surface of the polymeric components may be rendered suitable for bone ingrowth by the application of a porous layer. The porous layer may be applied to a part of the external surface, or to the whole of the surface. The external surface of the polymeric component may be rough or may comprise at least one protruberance (e.g. spike). The porous layer may be formed of metal particles (e.g. titanium), hydroxyapatite particles or any other suitable particles. The porous layer may be applied to the external surface of the polymeric component by any suitable means, such as by a cool plasma spray process or a heat pressing process. Ideally the particles are applied as a single layer of particles.

The porous layer may be formed by heat pressing a portion of each of the individual particles into the polymeric component. However, it is difficult to obtain a single layer of particles since some particles end up loosely attached to other particles and not the polymer component. These particules are then prone to being knocked off upon insertion of the polymer component into a patient, resulting in undesirable debris. In order to solve this problem, the porous layer may be formed by sintering particles onto a metal shell and attaching the shell to the polymeric component. Alternatively, the porous layer may be formed by sintering a plurality of particles together and then heat pressing the porous layer partially into the polymeric component. The porous shell may be formed in a mould with non-stickable surfaces (e.g. smooth ceramic). The porous shell may be configured to be, for example, 0.5 m to 1 mm thick. As all of the individual particles are effectively ‘welded’ together there is less chance of introducing debris. Such a polymeric component may be suitable for use in acetabular cups, tibial and patella components of knees, ankles, spine disc replacements, shoulders, jaws, ankles, toes, elbows, wrists, fingers or thumbs.

According to a further aspect of the invention there is provided a method of forming a polymeric component comprising: forming a porous layer by sintering a plurality of particles together; and heat pressing the porous layer partially into a polymeric layer.

Other features described above in relation to the first aspect of the invention may apply equally to the further, second, third or fourth aspect of the invention as appropriate, and vice versa.

The Applicant has discovered that in processes involving the re-melting or annealing below the melt temperature of radiation crosslinked polymer, the crosslink density in the material is lowered. They therefore propose that the act of heating crosslinked polymer causes some loss of crosslinking. The Applicants consequently propose the use of terminal radiation sterilisation to recover the crosslink density, post fabrication. However, this further radiation process will result in undesirable free-radicals and, as a result, terminal sterilisation is traditionally carried out by ethylene oxide or gas plasma sterilisation rather than radiation sterilisation. However, the Applicants have found that if the crosslinked polymer contains antioxidant prior to radiation sterilisation, the antioxidant will eradicate the resulting free radicals and so the crosslinked density can be restored without any adverse effects.

In order to verify the above, the Applicant has performed a series of experiments using vitamin E blended and consolidated polyethylene. The post-consolidation radiation crosslinking dose was varied from 50, 75, 100, 125, 150, 200, and 250 kGy. Samples of each dosing regime were then air annealed for 4 hours followed by slow cooling for 15 hours. The annealing temperatures used were 135, 150, 160 and 170 degrees C. The crosslinked density was measured in the samples before and after air annealing. The crosslinked density was found to fall in all samples as a result of the heating process. All samples were then subjected to either 25 or 50 kGy of gamma sterilising radiation. The results were that 25 kGy of radiation improved the crosslinked density and 50 kGy of radiation either nearly or fully restored the crosslinked density to the pre-heating levels.

In summary, the Applicants have found that, if a crosslinked polymer contains an antioxidant, then the way to overcome the disadvantage of reduced crosslinking with annealing or remelting or overmoulding is to use terminal radiation sterilisation. This process may be employed in conjunction with any prior art process as well as in conjunction with the various aspects of the present invention.

According to a third aspect of the present invention, there is provided a method of forming a polymeric component comprising one or more fixing means (i.e. fixing member) therein, the method comprising the steps of:
providing one or more fixing means, wherein the one or more fixing means are held in a predetermined position by a positionning means (i.e. positioner);
moulding polymeric material around the one or more fixing means such that the one or more fixing means become embedded in the polymeric material; and
removing the positioning means.

Polymeric components may be provided with one or more fixing means (fixing member) to facilitate attachment of a prosthesis polymeric component to bone, for example where a press fit is not sufficient for secure attachment. Thus the present invention provides a process of providing a polymeric component which is capable of having supplementary fixation, by moulding the polymer around a fixing means. This process may be referred to as ‘overmoulding’. The fixing means may become partially or completely embedded in the polymeric material.

The fixing means may be configured for the attachment of a modular peg. It has not been considered viable to attempt to fix modular pegs to the external surface of the polymeric component itself because of the poor mechanical properties of polymers, such as polyethylene, for such attachment. In a particular embodiment, the fixing means comprises a screw housing comprising a cavity having an internal screw-thread. In this case, the modular pegs would include a base having a complementary external screw thread. Fixing means may conveniently be provided in two- or more part prosthesis systems. For example, by having an array of screw housings on the undersurface of a polyethylene bearing insert for a fixed bearing knee replacement, secure fixation may be provided by several screws passing through the tibial metal baseplate into the screw housings. The fixing means may comprise or constitute metal and/or PEEK.

By a “predetermined position”, it will be understood that the fixing means is held at precisely the right position in the polymeric material such that, for example, after moulding and/or fashioning the polymeric material to produce the final polymeric component, the external surface of the fixing means is flush with the external surface of the polymeric component and is located in the required position.

The moulding step may comprise compression moulding using heat and/or pressure to mould the polymeric material, followed by cooling and consolidation of the moulded polymer.

In an embodiment, the positioning means (positioner) is provided by a mould which also serves to mould the polymeric material into the desired shape of the final polymeric component. The interior surface of the mould may comprise one or more recesses or protrusions which hold the fixing means in the desired position during moulding of the polymeric material. On removal of the mould (and the positioning means) the external surface of the fixing means is flush with the surface of the polymeric component.

In an alternative embodiment, the positioning means (positioner) is provided by one or more struts. In this embodiment, the polymeric material is then moulded around the fixing means held by the strut(s) so that the fixing means become partially or completely surrounded by the polymeric material. The strut(s) may then be removed from the polymer, for example by sliding or cutting the strut(s) out of the polymer mass.

The method may comprise the additional step of fashioning a polymeric component from the moulded polymer such that the fixing means is flush with the surface of the polymeric component. Alternatively, the method may comprise the additional step of fashioning the moulded polymer into a preform, a base or a compressor having one or more fixing means therein for use in the method of the first or second aspects of the invention. The step of fashioning a polymeric component or a preform, base or compressor may comprise machining the moulded polymeric material into a pre-defined shape.

The step of removing the positioning means may be carried out before or after the polymeric component or preform/compressor/base is fashioned from the moulded polymeric material.

Conveniently, this method may be used to form a plurality of polymeric components, each comprising one or more fixing means therein, by:
providing a plurality of fixing means, wherein the fixing means are held in predetermined positions by one or more positioning means;
moulding polymeric material around the plurality of fixing means such that the fixing means become embedded in the polymeric material;
fashioning a plurality of polymeric components from the moulded polymeric material; and
removing the positioning means.

The overmoulding process of the third aspect of the invention may be useful for incorporating fixing means into polymeric components (or preforms, bases or compressors) which are fully crosslinked. To provide a fully crosslinked polymeric component or a preform, base or compressor having one or more fixing means therein, the method may additionally comprise the step of crosslinking the polymeric material, for example by chemical or radiation crosslinking of the polymeric material. The crosslinking may be carried out before, during or after moulding.

In an embodiment, the polymer is radiation crosslinked. After radiation crosslinking, the polymeric material may be subject to the additional step of re-melting or annealing.

The polymeric material may comprise an antioxidant (e.g. vitamin E). The antioxidant may be introduced to (e.g. blended with or doped into) the polymeric material before, during or after crosslinking. After moulding and cooling, the antioxidant-containing polymeric material may be radiation crosslinked followed by re-melting or annealing. Re-melting or annealing may be carried out before or after the final polymeric component has been fashioned from the moulded polymeric material. Optionally, the re-melting or annealing step may be followed by a further step of radiation sterilisation. Radiation sterilisation is generally carried out as the last step of the process, i.e. after the polymeric component has been fashioned or machined from the moulded polymeric material.

The overmoulding process may be used to incorporate fixing means into hybrid components comprising crosslinked and non-crosslinked layers, which may be produced in accordance with the first or second aspect of the invention.

Thus, in an embodiment of the first or second aspects of the invention, the crosslinked preform, base or compressor may comprise one or more fixing means therein. The crosslinked preform, base or compressor may be produced by overmoulding in accordance with the third aspect of the present invention. The one or more fixing means may be positioned in the preform, base or compressor such that upon fashioning of the final polymeric component from the hybrid component, the one or more fixing means are flush with the surface of the final polymeric component.

In an alternative embodiment of the first or second aspect of the present invention, the method may further comprise a step of inserting a fixing means into the non-crosslinked polymeric material, prior to fusing of the non-crosslinked polymeric material to the crosslinked preform or base. The fixing means may be held in a predetermined position in the non-crosslinked polymeric material by a positioning means, such as a strut. The fixing means will then be fixed in position in the non-crosslinked polymer by the moulding process which is used to fuse the preforms/base/compressor to the non-crosslinked material. The fixing means may be positioned in the non-crosslinked polymeric material such that upon fashioning the hybrid component to form the final polymeric component, the fixing means is flush with the surface of the final polymeric component.

The fixing means may advantageously have a higher melting point than the crosslinked polymeric material so that it is capable of withstanding the fusing process. Suitably the fixing means may comprise or constitute metal and/or PEEK.

According to a fourth aspect of the present invention, there is provided a method of forming a polymeric component comprising one or more fixing means therein, comprising the steps of:
providing moulded polymeric material; and
inserting one or more fixing means into the moulded polymeric material;

The insertion of fixing means into pre-moulded polymeric material may also be referred to as ‘after-moulding’. The step of inserting the fixing means may comprise providing a recess in the moulded polymeric material in the desired location, for example by machining, and securing the fixing means in the recess.

In an embodiment, the fixing means is secured in the recess by thermal installation. In this embodiment, the fixing means is heated above the melting point of the polymeric material and heat-pressed into position in the recess. The external surface of the fixing means is ideally provided with undercuts or contours (e.g. channels or recesses). The heat causes the polymeric material to melt or plasticise and flow into the undercuts or contours of the surface of the fixing means, thus securing the fixing means in place upon cooling and solidification of the polymeric material. Thermal installation may be carried out by heat element welding or electromagnetic resistance welding.

In an alternative embodiment, the fixing means is secured in the recess by ultrasonic welding. This process comprises applying ultrasonic energy to the fixing means to generate heat, which again causes melting of the adjacent polymeric material as the fixing means is inserted into the recess. The molten or plasticised polymeric material flows around the fixing means and into any undercuts and contours that may be present in the external surface of the fixing means. Solidification of the polymeric material causes the fixing means to be locked into position in the polymer.

The use of thermal installation and ultrasonic welding has not previously been considered as suitable for the purposes of inserting fixing means into prosthetic polymeric components or polymeric medical devices. This is because polyethylene, which is normally used to form prosthetic bearing components in joints, is at risk of oxidation and embrittlement caused by the heating and melting step. Such oxidation and embrittlement may not be a problem for some applications or industries where the lifetime of the polymer product is only a few years, or where the development of a loose fixing means caused by polymer degredation over time could easily be repaired, for example by gluing. However, in the field of medical products or prosthetics, such as hip bearings, the product may be in use for many decades, and it is therefore important that the insertion of the fixing means does not cause damage to the polymeric material by inducing oxidation and embrittlement. The inventor has found that the presence of an antioxidant, such as vitamin E, prevents oxidation of the polymeric material upon heating, thereby making thermal installation techniques viable for medical and prosthetic components. Thus, in an embodiment, the polymeric material comprises an antioxidant (e.g. vitamin E).

The polymeric material may be medical grade polyethylene.

In a further embodiment, the fixing means is secured in the recess by providing a fixing means having an external screw thread which mates with a complementary internal screw thread provided in the recess. This provides an interference fit between the fixing means and the polymeric material. The fixing means may be further secured in the recess using glue to improve the interference fit.

The moulded polymeric material may be fully crosslinked. Cross-linking may be carried out prior to or after the step of inserting the fixing means into the polymeric material.

In an embodiment, the method comprises the additional step of fashioning a polymeric component from the moulded polymeric material. In this embodiment, the step of inserting one or more fixing means into the moulded polymeric material may be carried out prior to or after the step of fashioning the polymeric component from the moulded polymeric material.

In another embodiment, the moulded polymeric material is a hybrid component or a polymeric component fashioned therefrom, comprising crosslinked and non-crosslinked layers, made in accordance with first or second aspect of the invention.

The fixing means may be inserted into the crosslinked and/or the non-crosslinked layer.

The polymeric component may be configured as a medical device or a prosthetic component, such as an acetabular cup.

Thus, in an embodiment of the first or second aspect of the present invention, the method further comprises a step of inserting one or more fixing means into the hybrid components or the final polymeric components using after-moulding.

Further embodiments described in relation to the first, second or third aspects of the invention may equally apply to the fourth aspect of the invention, and vice versa.

### BRIEF DESCRIPTION OF THE DRAWINGS

Embodiments of the invention will now be described, by way of example only, with reference to the accompanying figures, in which:

FIG. 1 shows a front cross-sectional view showing a crosslinked preform being compression moulded to non-crosslinked powder in accordance with an embodiment of the present invention;

FIG. 2 shows a front cross-sectional view of a hybrid polymeric component fashioned from the moulding of FIG. 1;

FIG. 3 shows a plan view of a bottom mould plate provided with a few illustrative preforms arranged for the moulding method shown in FIG. 1;

FIG. 4 shows a front cross-sectional view similar to that of FIG. 1 according to a second embodiment of the present invention;

FIG. 5 shows a front cross-sectional view of a hybrid polymeric component fashioned from the moulding of FIG. 4;

FIG. 6 shows a front cross-sectional view of an alternative hybrid polymeric component fashioned from the moulding of FIG. 4;

FIG. 7 shows a front cross-sectional view of a tibal component produced in accordance with an embodiment of the invention;

FIG. 8 shows a side part cross-sectional view of the tibal component shown in FIG. 7;

FIG. 9 shows a front cross-sectional view showing a crosslinked preform being compression moulded to non-crosslinked powder, which in turn is being compression moulded to a crosslinked base, in accordance with a further embodiment of the present invention;

FIG. 10 shows a front cross-sectional view of a hybrid polymeric component fashioned from the moulding of FIG. 9;

FIG. 11 shows a cross-sectional view of a modular peg in a screw housing which has been inserted into a polymeric layer in accordance with an embodiment of the present invention;

FIG. 12 shows an underneath view of the screw housing shown in FIG. 11;

FIG. 13 shows a front cross-sectional view showing the insertion of a screw housing into non-crosslinked polymeric material during the compression moulding of the non-crosslinked material to a crosslinked polymeric preform, in accordance with an embodiment of the present invention; and

FIG. 14 shows a front cross-sectional view of a hybrid polymeric component comprising a screw housing, fashioned from the moulding of FIG. 13.

### DETAILED DESCRIPTION OF CERTAIN EMBODIMENTS

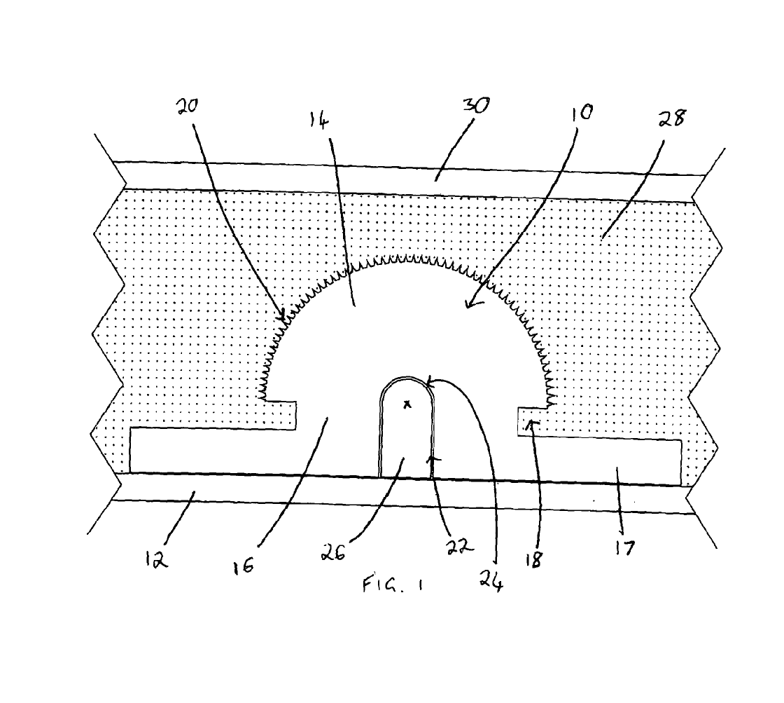

FIG. 1 illustrates a method of forming a plurality of polymeric components (in the present case, acetabular cup prosthesis) in accordance with an embodiment of the present invention. The method comprises providing an array of preforms 10 on a planar mould plate 12, each preform 10 comprising crosslinked polyethylene, which was mixed with 0.1% by weight of an antioxidant in the form of vitamin E, prior to consolidation. Although only one preform 10 is shown in FIG. 1, it will be understood that, in practice, multiple preforms 10 would be provided to form the array on the mould 12.

Each preform 10 comprises a hemi-spherical element 14 which is joined by a cylindrical trunk 16 to a disc-shaped substrate 17, which is 60 mm in diameter. The cylindical trunk 16 has a diameter less than that of the hemi-spherical element 14 and is centrally disposed so as to provide an annular undercut 18 between the bottom of the hemi-spherical element 14 and the substrate 17 (which has a diameter larger than the hemi-spherical element 14). The hemi-spherical element 14 has an exterior surface 20 which is roughened to aid attachment to the non-crosslinked material, as will be described in more detail below. In the present embodiment, the exterior surface 20 is roughened by machining grooves to form spikes on the exterior surface 20. However, in other embodiments, the rough surface can be produced by hot or cold stamping a smooth external surface or the rough surface could be directly moulded with the preform 10.

In one embodiment, the preforms 10 are consolidated by compression moulding (alternatively ram extrusion may be employed). The consolidated preforms 10 and are then irradiated with a dose of 150 kGy to induce crosslinking, while the antioxidant serves to eliminate, or at least minimise, oxidation. It should be noted that no re-melting of the consolidation is necessary since the antioxidant alone can combine with the free radicals to minimise oxidation.

A socket 22 is machined into the substrate 17 and along a central axis of the trunk 16. The socket 22 is in the shape of a test-tube having a tip 24 with a centre of curvature X which is coincident with a centre of curvature of the hemi-spherical element 14. A correspondingly shaped metal rod 26 is then inserted into the socket 22. For the manufacturer's reference, it is envisaged that each rod 26 will include markings to indicate the outer diameter (OD) and inner diameter (ID) of the acetabular cup to be machined from its associated preform 10.

Next, non-crosslinked polyethylene powder 28 is poured on top of the mould 12 and over and around the preforms 10 to completely fill the undercuts 18 and any spaces between the respective preforms 10 and to provide a sufficient thickness of powder 28 above the hemi-spherical element 14 of the preforms 10. The non-crosslinked polyethylene powder 28 in the present embodiment comprises 2.0% by weight of blended vitamin E. In other embodiments, the percantage of vitamin E provided may be in the range of from below 0.1% by weight up to 3% by weight. However, it is preferable that the percantage of vitamin E employed be within the range of 0.5% by weight to 2% by weight. Although the use of vitamin E is described herein, any suitable antioxidant can be used.

An upper planar mould plate 30 is provided over the non-crosslinked polymer powder 28 and the mould is heated up above the melting temperature of the polyethylene and pressure is applied between the mould plates 12, 30. A typical moulding cycle for this embodiment would last approximately 24 hours. The non-crosslinked polyethylene powder 28 and the crosslinked preforms 10 both melt in the mould and on cooling fuse into a sheet of hybrid components. The heat of moulding allows the free radicals in the crosslinked polyethylene to be eliminated while the antioxidant present in the non-crosslinked polyethylene powder 28 is allowed to diffuse into the crosslinked polyethylene to further consume any free radicals and reduce oxidation.

It will be noted that the substrates 17 are large enough to stabilise the preforms 10 and prevent them from toppling over when pressure is applied to the mould plates 12, 30. Furthermore, the diameter of the substrates 17 is large enough to separate the hemi-spherical elements 14 from each other so that these are surrounded with a sufficiently thick layer of non-crosslinked polyethylene powder 28.

The rod 26 is removed after the fusing of the preforms 10 to the non-crosslinked polyethylene powder 28 and a plug cutter having cutting teeth arranged to cut a 60 mm diameter circle is used to cut through the thickness of the moulded sheet, centred on the socket 22. This step therefore separates each hybrid component in a hybrid block taken from the moulded sheet so that each hybrid block can be individually machined into a desired component.

The method therefore further comprises machining (i.e. fashioning) each hybrid block into one of a pluarlity of polymeric components, taking reference from the known centre X in the socket 22.

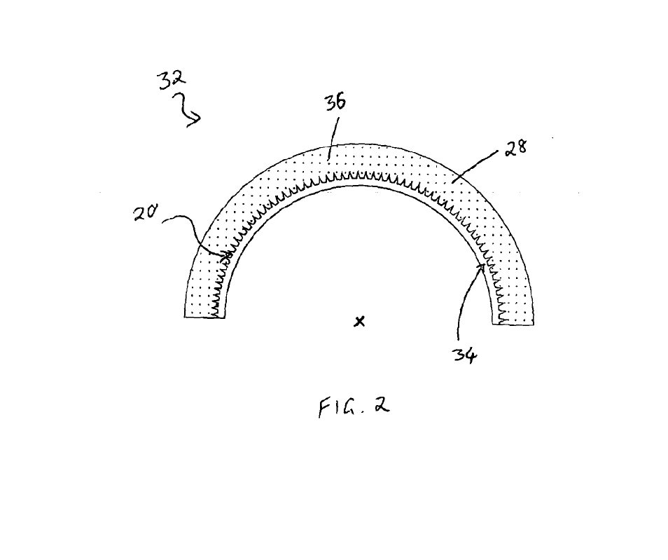

One example of a hybrid polymeric component 32 fashioned from the moulding method described in relation to FIG. 1, is shown in FIG. 2. Thus, the hybrid block has been machined to remove a portion of the preform 10 so as to deposit a concave crosslinked surface layer 34 on an inner surface of a spherical shell 36 machined from the non-crosslinked polyethylene powder 28. Accordingly, the component 32 comprises a surface layer 34 which is highly crosslinked and suitable for wear resistance and a bulk portion 36 which is non-crosslinked and therefore has maximum strength. Because the two layers have slightly different mechanical characteristics, the roughened surface 20 provides a transition region, thus avoiding abrupt changes in the mechanical properties and minimizing the risk of de-lamination during use.

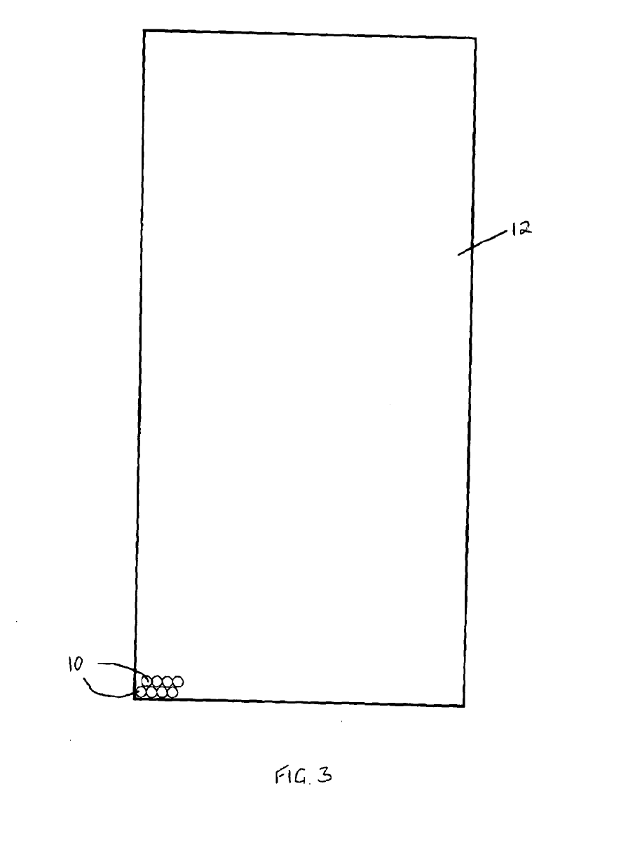

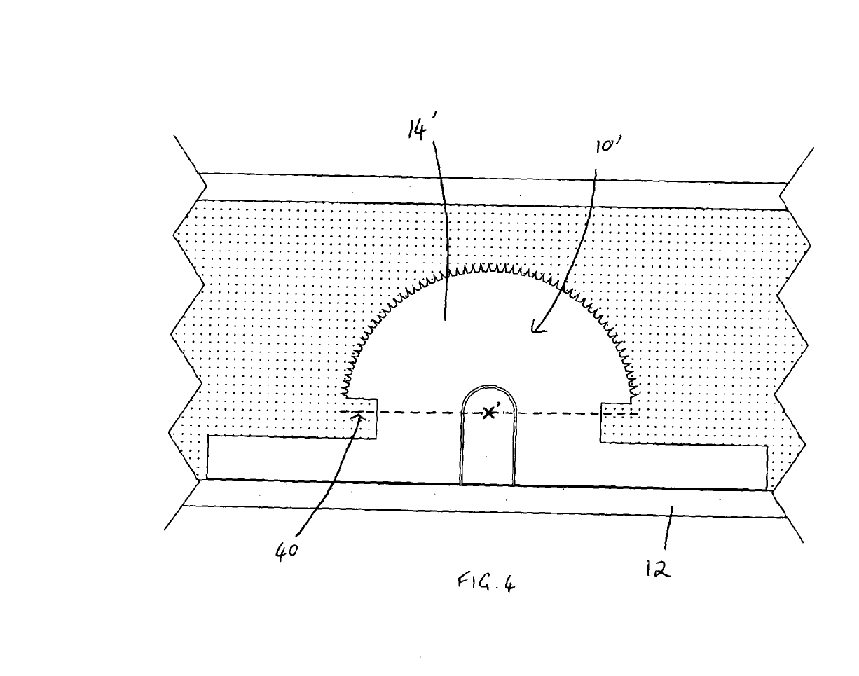

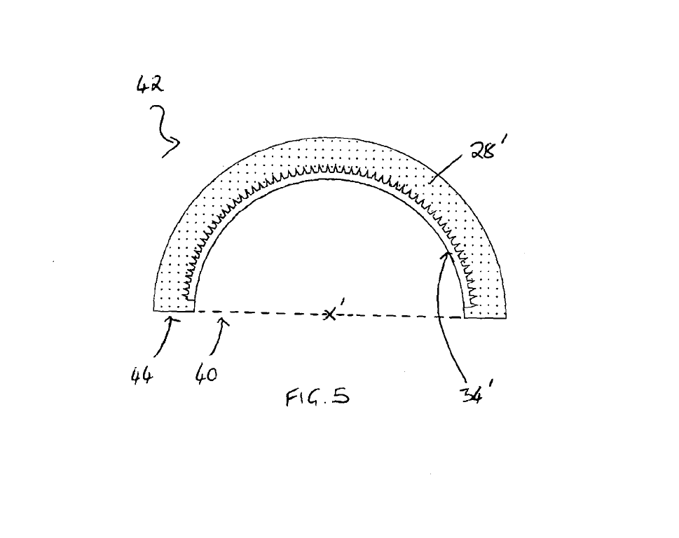

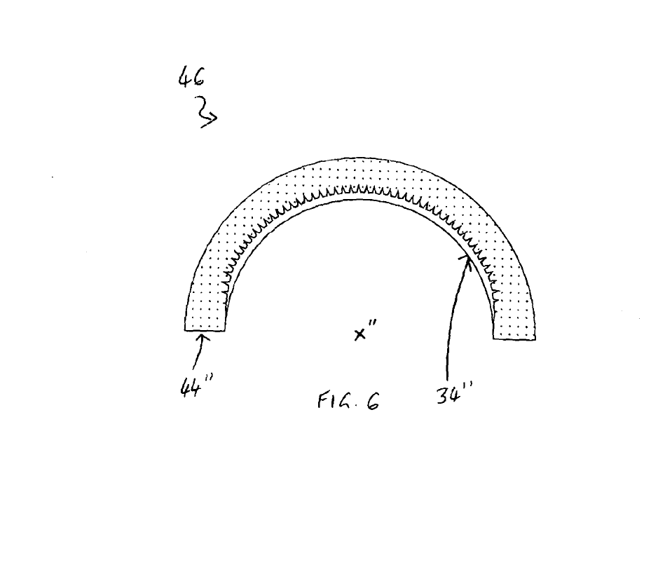

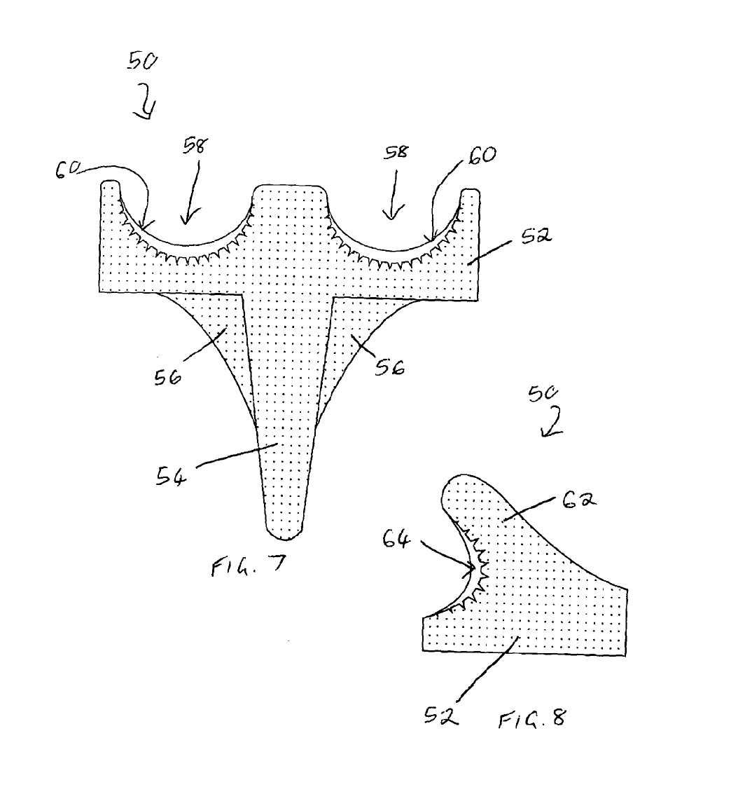

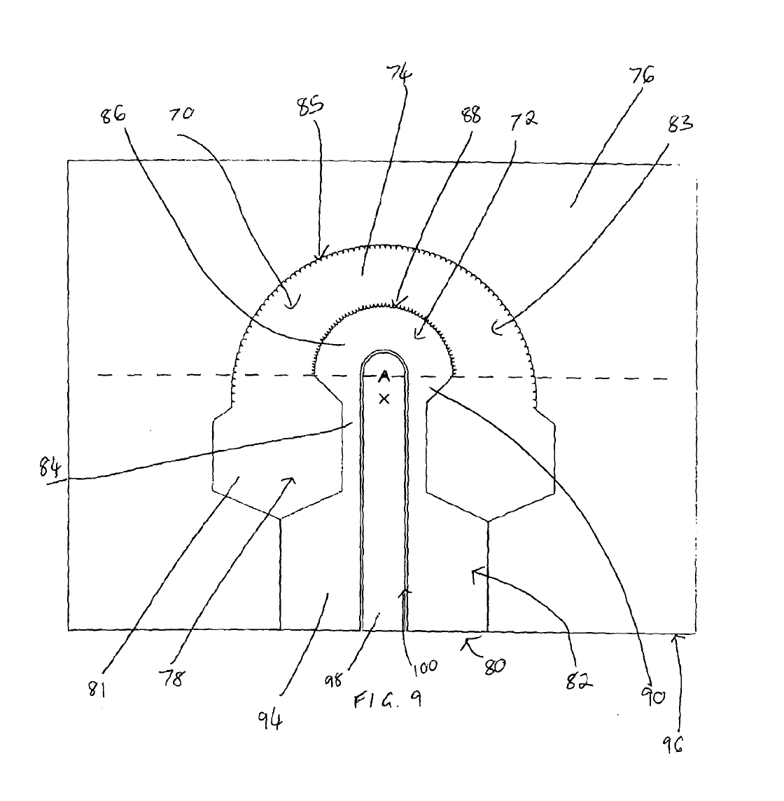

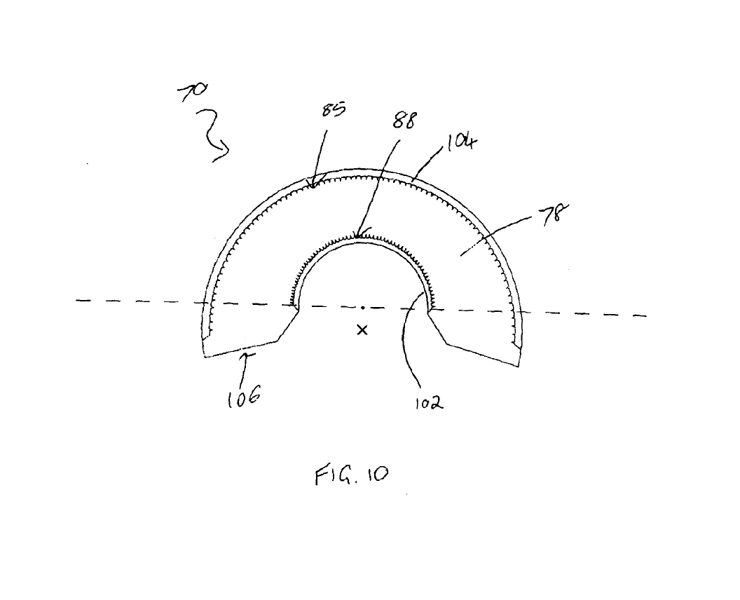

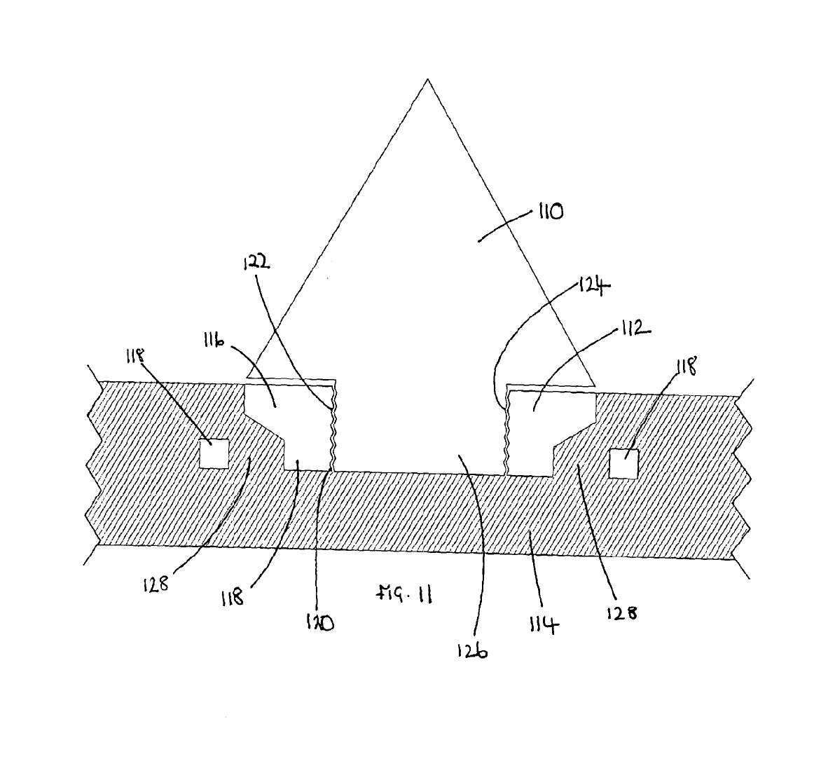

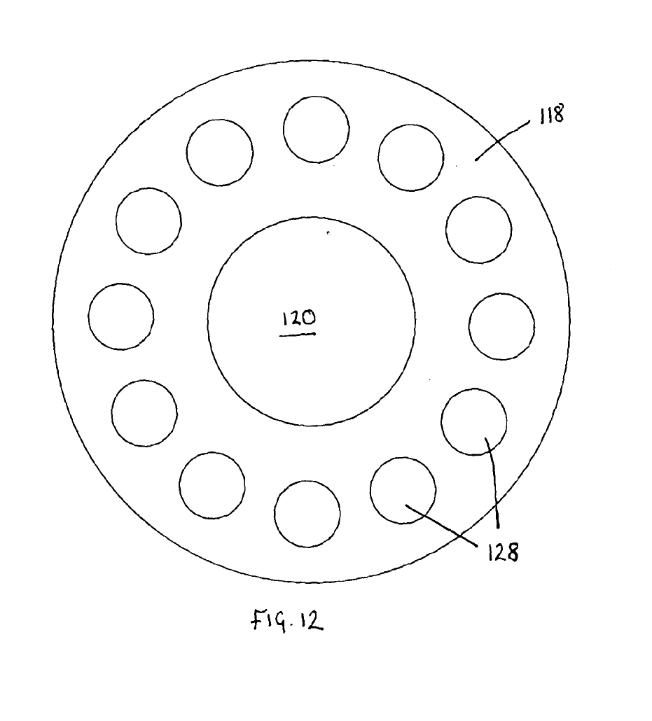

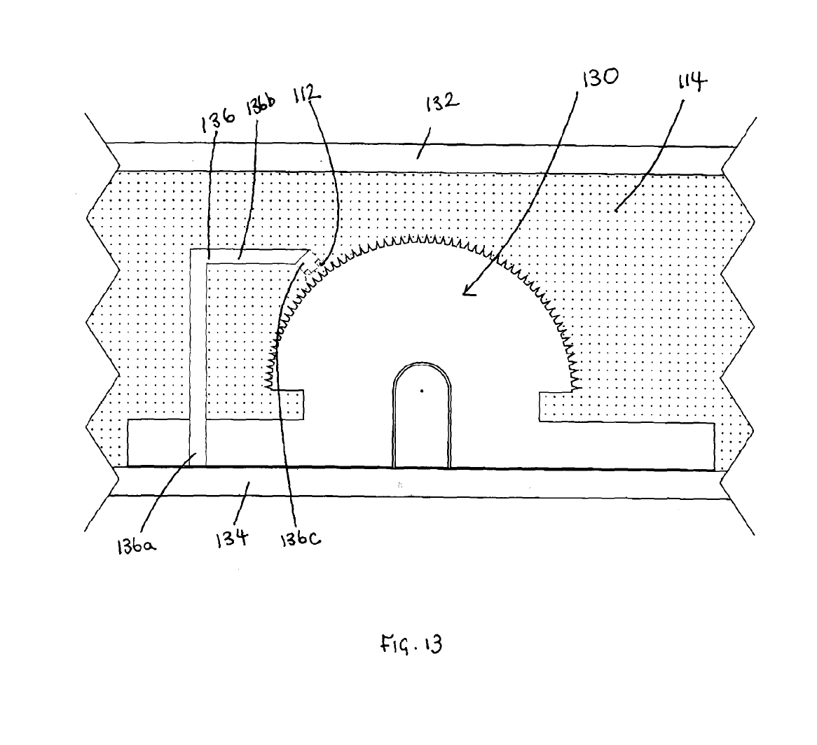

FIG. 3 shows a plan view of a bottom mould plate 12 provided with a few illustrative preforms 10 arranged for the moulding method shown in FIG. 1. Although only 8 preforms 10 are shown in close proximity on the mould plate 12, in practice, the mould plate 12 would be filled with preforms 10 before the non-crosslinked polyethylene powder 28 is added to the mould. The applicant has found that it is possible to create approximately 2,200 hybrid components 32, like that shown in FIG. 2, by arranging approximately 2,200 preforms 10 on a typical 4 m by 2 m compression mould plate 12 and carrying out the method described above.

FIG. 4 shows a front cross-sectional view similar to that of FIG. 1, according to a second embodiment of the present invention. In fact, the only difference between the method illustrated in FIG. 4 and that of FIG. 1 is that the preform 10′ comprises a part-spherical (as opposed to a hemi-spherical) element 14′ which subtends less that 180 degress so that it stops short of the diameter line 40 taken through the centre of curvature X′ and drawn parallel to the mould plate 12.

Accordingly, the perform 10′ shown in FIG. 4 can be machined into a bearing component 42, as shown in FIG. 5, where the crosslinked bearing surface 34′ stops short of the edge 44 of the component 42, leaving consolidated (mechanically strong) non-crosslinked polyethylene powder 28′ along the edge 44 of the component 42.

FIG. 6 shows a front cross-sectional view of an alternative hybrid polymeric component 46 which is similar to that shown in FIG. 5 except that the preform 10′ has been machined to provide a crosslinked surface layer 34″ having a thickness which tapers (i.e. feathers away) towards the edge 44″.

FIG. 7 shows a front cross-sectional view of a tibal component 50 produced in accordance with an embodiment of the invention. More specifically, FIG. 7 shows a section through an all-polyethylene fixed bearing knee replacement tibial component 50. The component 50 comprises a tibial tray 52, a stem 54, anti-rotation flanges 56, and two recesses 58 for femoral condyle articulation. The articular surface 60 bounding each recess 58 is provided with a layer of crosslinked polyethylene which has been deposited on the non-crosslinked remainder of the component 50 by a similar method to that described above, the only significant difference being the non-crosslinked material is machined into the shape of a tibal component as opposed to an acetabular cup.

FIG. 8 shows a side part cross-sectional view of the tibal component 50 shown in FIG. 7, which illustrates a peg 62 provided between the two recesses 58, for an articulating cam and peg mechanism. Maximum strength is maintained by keeping the bulk of the tibial tray 52 and the bulk of the peg 62 formed from non-crosslinked polyethylene. However, for improved wear resistance, the articular surface 64 of the peg 62 is provided with a crosslinked polyethylene layer deposited in a similar method to that described above, in accordance with the present invention.

FIG. 9 shows an embodiment of the present invention where the method is employed to produce a dual mobility bearing 70 having front and rear bearing surfaces (shown in FIG. 10) for a total hip replacement. In essence, such bearings 70 comprise a polyethylene sandwich formed by a consolidated crosslinked polyethylene compressor (preform) 72 which is compression moulded to non-crosslinked polyethylene powder 74 and which, in turn, is compression moulded to a consolidated crosslinked polyethylene base 76.

The base 76 is formed from a cylindrical block of highly crosslinked polyethylene which contains antioxidant in the form of 0.2% by weight of vitamin E. Into this cylinder is machined an axially disposed cavity 78 open at one end 80. The cavity 78 comprises a tubular outermost section 82, an enlarged portion 81 and a concave hemi-spherical innermost section 83 which has a roughened surface 85.

The compressor 72 (which can be considered a form of piston) comprises a preform 84 similar to those described above. The compressor 72 comprises a hemi-spherical element 86 with a roughened exterior surface 88, an inwardly tapering shoulder 90 depending from the edge of the hemi-spherical element 86, a cylindrical neck portion 92 depending from the shoulder and which is connected to a large generally cylindrical section 94 which is wider than the hemi-spherical element 86 and which is configured for close sliding engagement in the tubular outermost section 82 of the base 76.

A gap is provided between the hemi-spherical cavity 83 and the hemi-spherical element 86 for receipt of the non-crosslinked polyethylene powder 74, which contains approximately 0.2% by weight of vitamin E.

The base 79 is provided in a metal cylinder 96 and the powder 74 is cold compressed by pressing approximately 10 tonnes on the compressor 72. It will be noted that an appropriate volume of powder 74 has to be employed so that, once compressed, the hemi-spherical element 86 is disposed a desired distance from the hemi-spherical cavity 83 so as to provide the intended thickness of non-crosslinked polyethylene powder 74 therebetween.

It will also be noted that, once compressed, the centre of the hemi-spherical cavity 83 (X) is not coincident with the centre of the hemi-spherical element 86 (A). Instead, the centre X is closer to the open end 80 than the centre A so that the non-crosslinked polyethylene powder 74 is thinest at the pole of the cup and this provides a ‘self-aligning’ feature.

As before, a metal rod 98 is inserted into a socket 100 extending axially through the compressor 72 to mark the centre A of the hemi-spherical element 86, which will consititute the inner centre of the cup.

A hybrid puck is then hot compression moulded. Although this may be performed, as illustrated, for individual compression mouldings, ideally an array of compressors 72 could be arranged on an industrial compression moulding press (similar to that shown in FIG. 3) and many pucks could be moulded en mass.

Once moulded, each puck is machined into the dual mobility bearing 70 shown in FIG. 10. Accordingly, a thin layer of crosslinked polyethylene material 102 is left on an inner aspect of the bearing 70 and a thin layer of crosslinked polyethylene material 104 is left on an outer aspect of the bearing 70, with the roughened surfaces 85, 88 of the compressor 72 and base 76 providing transition regions into the non-crosslinked polyethylene material 78 therebetween. As is common practice, the inner aspect of the bearing 70 is machined so that is extends to slightly more than 180 degrees, making the femoral head a snap fit in the bearing 70.

In the present embodiment, the inner articular surface 102 is completely crosslinked but in the outer articular surface, the crosslinked layer 104 stops short of the edge 106. However, the extent of each crosslinked layer can be varied according to the design requirements.

It is also shown that the non-crosslinked polymeric material 78 has a free edge 106 which is not in contact with crosslinked polymeric material 102, 104 and which is configured to withstand impingement by a femoral component, when in use. Accordingly, the present embodiment provides for wear zone only surface crosslinking on the outside and inside of the bearing 70, leaving the edge 106 and body of the bearing 70 as strong conventional polyethylene.

FIG. 11 shows an embodiment of the present invention wherein a modular peg 110 is held in a screw housing 112 that has been inserted into a non crosslinked polyethylene layer 114 of a hybrid polymeric component. The screw housing 112 is preferentially made of PEEK but could instead be made of another strong bio-compatible material, such as metal. Typically two pegs 110 would be attached to a polymeric component that forms an acetabular cup. In the emodiment shown, the screw housing 112 is 3 mm deep and consists of an outer disc 116, typically 12 mm in diameter, connected to an inner disc 118, typically 15 mm in diameter. A hole 120 is provided through the centre of both discs 116, 118, the hole 120 having an internal screw thread 122 for engagement with a complementary external screw thread 124 provided on a base 126 of the peg 110.

The inner disc 118 is perforated by a plurality of holes 128, as shown by FIG. 12. During the moulding process the molten polyethylene 114 permeates through the holes 128, giving a strong mechanical bond between the non-crosslinked polyethylene layer 114 and the screw housing 112 upon cooling and consolidation.

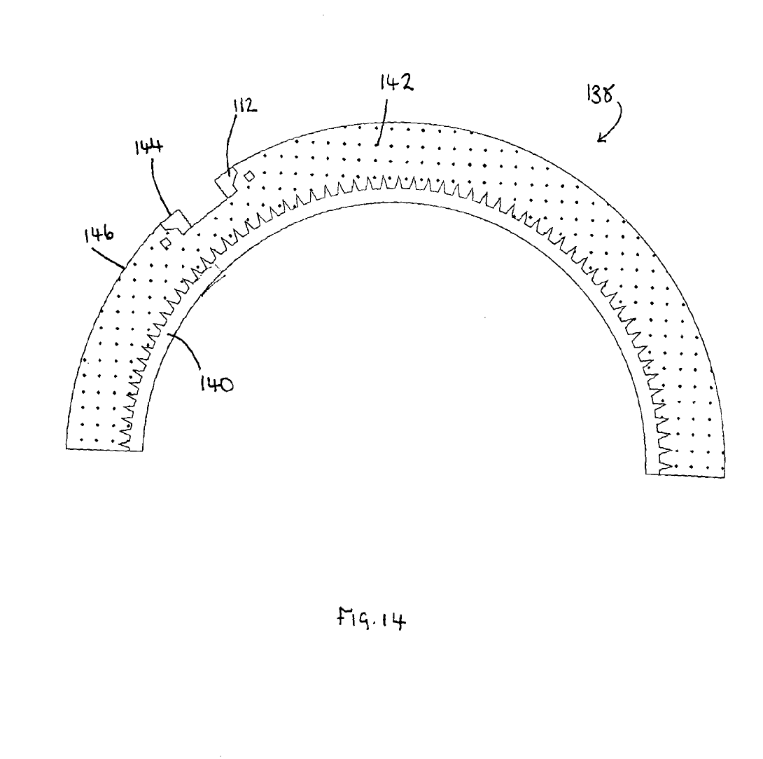

FIG. 13 illustrates a method of forming a polymeric component having a screw housing therein, in accordance with an embodiment of the present invention. In the embodiment shown, the polymeric component is formed as previously described by fusing a crosslinked preform 130 with non-crosslinked polyethylene powder 114 held between two mould plates 132, 134. A screw housing 112 is held by a support 136 in a precise predetermined position relative to the perform 130. The support 136 comprises vertical and horizontal struts 136a, 136b and a terminal engaging portion 136c. As shown, the terminal engaging portion 136c screws into the central screw hole 120 of the screw housing 112, providing secure fixation and preventing molten polyethylene 114 from filling up the screw hole 120. After fusion, cooling and consolidation, the support 136 can be sectioned or slid out of the polyethylene mass. For example, the vertical strut 136a may be made of metal which can be slid out of the polymer mass, while the horizontal strut 136b may be made of PEEK which can easily be cut out.

Although only one support 136 is illustrated in the embodiment shown, it will be appreciated that two or more supports may be used to position two or more screw housings 112 so that the final polymeric component has multiple screw housings 112. For example, in the case of an acetabular cup having a long posterior wall, four screw housings may be inserted so that two of the screw housings may be used for a right hip and the other two may be used for a left hip, allowing the posterior lip to be correctly sited for each hip side. The inclusion of further screw housings gives the surgeon the ability to fine-tune the position of the long posterior wall by using any two of an array of screw housings.

An example of a hybrid polymeric component 138 produced by the moulding method described in relation to FIG. 13, is shown in FIG. 14. The hybrid block formed from the fusion of the crosslinked preform 130 and the non-crosslinked polyethylene 114 has been machined to remove a portion of the preform 130, leaving a crosslinked surface layer 140 on an inner surface of a shell 142 machined from the non-crosslinked polyethylene powder 114. Embedded in the non-crosslinked shell 142 is the screw housing 112, positioned such that an external surface 144 of the screw housing is flush with an external surface 146 of the non-crosslinked shell 142.

It will be understood that embodiments of the present invention provide an efficient and effective method of grafting a highly crosslinked fully consolidated polyethylene articular surface onto a non-crosslinked polyethylene main part. Although aspects of the invention have been described above in relation to an acetabular cup prosthesis, the invention is applicable to large scale production of polyethylene parts for non-medical use as well as for various joint replacement components.

It will be appreciated by persons skilled in the art that various modifications may be made to the above embodiment without departing from the scope of the present invention. For example, features described in relation to one embodiment may be mixed and matched with features described in relation to one or more other embodiments.

1. A method of forming a plurality of polymeric components comprising:
providing an array of preforms, each preform comprising crosslinked polymeric material;
providing non-crosslinked polymeric material around at least a portion of each preform;
fusing the array of preforms to the non-crosslinked polymeric material so as to form a plurality of hybrid components;
removing a portion of each preform so as to deposit a crosslinked surface layer on the non-crosslinked polymeric material; and
fashioning the hybrid components into said plurality of polymeric components.

2. The method according to claim 1 wherein the array of preforms is constituted by a plurality of interconnected preforms.

3. The method according to claim 1 wherein each preform has a digitated or roughened portion to help in fusing the crosslinked polymeric material to the non-crosslinked polymeric material.

4. The method according to claim 1 wherein the step of fusing the preforms to the non-crosslinked polymeric material comprises compression moulding.

5. The method according to claim 1 wherein the preforms are configured for attachment to a location and/or handling tool.

6. The method according to claim 5 wherein the preforms comprise a socket for receipt of a plug having a higher melting point than the crosslinked polymeric material or wherein the preforms comprise a plug for instrtion into a socket of a location and/or handling tool.

7. (canceled)

8. The method according to claim 6 wherein the plug is constituted by a rod which is inserted into the preform prior to the fusing of the preforms to the non-crosslinked polymeric material so as to form the plurality of hybrid components.

9. The method according to claim 8 wherein the rod is removed after fusing and a cutting tool is used, which takes reference from the location of the socket, so as to remove a required portion of the preform to deposit the crosslinked surface layer on the non-crosslinked polymeric material.

10. The method according to claim 1 wherein the polymeric components are configured as acetabular cup bearing components and the preforms comprise a part-spherical element joined by a cylindrical trunk to a planar substrate.

11-12. (canceled)

13. The method according to claim 10 wherein the non-crosslinked polymer powder is placed around the preforms to completely fill gaps provided between the trunks and the part-spherical surfaces of each preform.

14. The method according to claim 13 wherein, after fusing, a block of material is formed and the only indication of the position of each preform is provided by the positions of the sockets and the centre of curvature of the tips of the sockets.

15. (canceled)

16. The method according to claim 14 wherein the rods are removed and a cutting tool is employed to remove a pre-determined portion of the preform so as to leave a desired thickness of crosslinked surface layer on the non-crosslinked material.

17. The method according to claim 16 wherein the hybrid components are machined into part-spherical acetabular cups having the crosslinked surface layer constituting the whole or a part of the inner articular bearing surface.

18. The method according to claim 17 wherein a portion of the non-crosslinked material is maintained along an edge of the acetabular cup.

19. The method according to claim 1 comprising providing a further crosslinked polymeric layer on the non-crosslinked polymeric material.

20. The method according to claim 19 comprising the step of fusing the non-crosslinked polymeric material to a base of crosslinked polymeric material, prior to, subsequent to or at the same time as the step of fusing the preforms to the non-crosslinked polymeric material.

21. The method according to claim 20 wherein the base is formed into a further surface layer on the non-crosslinked polymeric material.

22-23. (canceled)

24. The method according to claim 1 wherein the step of fashioning the hybrid components comprises separating the hybrid components and/or machining the hybrid components into a pre-defined shape.

25-26. (canceled)

27. The method according to claim 1 wherein the crosslinked polymeric material and/or the non-crosslinked polymeric material comprises an antioxidant.

28. The method according to claim 27, further comprising radiation sterilisation.

29-64. (canceled)
